(19) United States
(12) Patent Application Publication
(10) Pub. No.: US 2014/0324381 A1
(43) Pub. Date: Oct. 30, 2014

(54) SYSTEM, METHOD AND/OR DEVICES FOR APPLYING BAROMETRIC PRESSURE MEASUREMENTS AND RADIO FREQUENCY MEASUREMENTS FOR POSITIONING

(71) Applicant: QUALCOMM Incorporated, San Diego, CA (US)

(72) Inventors: Sai Pradeep Venkatraman, Santa Clara, CA (US); Weiyi Liu, San Jose, CA (US); Gengsheng Zhang, Cupertino, CA (US)

(73) Assignee: QUALCOMM Incorporated, San Diego, CA (US)

(21) Appl. No.: 14/090,676

(22) Filed: Nov. 26, 2013

Related U.S. Application Data
(60) Provisional application No. 61/816,667, filed on Apr. 26, 2013.

(51) Int. Cl. G01C 21/00

(52) U.S. Cl. CPC G01C 21/00
USPC 702/138

(57) ABSTRACT

Disclosed are systems, methods and devices for applying barometric pressure measurements and radio frequency measurements for positioning. In one implementation, barometric measurements may indicate a transition between floors of a building. Accordingly, barometric measurements may be combined with detections of a particular floor based, at least in part, on acquired radio frequency signals.

### CROSS-REFERENCE TO RELATED APPLICATIONS

This application claims the benefit of and priority to U.S. Provisional Patent Application Ser. No. 61/816,667, entitled “System, Method and/or Devices for Applying Barometric Pressure Measurements and Radio Frequency Measurements for Positioning,” filed on Apr. 26, 2013, which is assigned to the assignee hereof and expressly incorporated herein by reference.

### BACKGROUND

1. Field

Embodiments described herein are directed to mobile navigation techniques.

2. Information

Hand-held mobile devices, such as cellphones, personal digital assistants, etc., are typically enabled to receive location based services through the use of location determination technology including satellite position systems (SPSs), indoor location determination technologies and/or the like. In particular implementations, a mobile device may be provided with positioning assistance data to enable the mobile device to estimate its location using one or more positioning techniques or technologies.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a system diagram illustrating certain features of a system containing a mobile device, in accordance with an implementation.

FIG. 2 is a plot illustrating changes in a location of a mobile device between floors as detected from barometric pressure measurements according to an embodiment.

FIGS. 3A, 3B and 3C comprise plots illustrating application of radio frequency (RF) measurements and barometric pressure measurements to detect transitions between floors of a building according to an embodiment.

FIG. 4A is a flow diagram of a process for combining the acquisition of RF signals with barometric pressure measurements for estimating an aspect of a location of a mobile device in accordance with an embodiment.

FIG. 4B is a flow diagram of a process for updating a vector showing probabilities according to an embodiment.

FIG. 5 is a schematic block diagram illustrating an exemplary mobile device, in accordance with an implementation.

FIG. 6 is a schematic block diagram of an example computing platform in accordance with an implementation.

### SUMMARY

Briefly, particular implementations are directed to a method comprising, at a mobile device: inferring a location of said mobile device as being on a particular floor of a multi-floor building based, at least in part, on acquisition of one or more radio frequency signals; and combining said inference of said location of said mobile device with barometric pressure measurements obtained from a barometric sensor device to infer said location.

In another particular implementation, a mobile device comprises: one or more barometric sensors to obtain barometric sensor measurements; and one or more processors to: infer a location of said mobile device as being on a particular floor of a multi-floor building based, at least in part, on acquisition of one or more radio frequency signals; and combine said inference of said location of said mobile device with barometric pressure measurements obtained from said one or more barometric sensors to infer said location.

In another particular implementation, an article comprises: a storage medium comprising machine-readable instructions stored thereon which are executable by a special purpose computing apparatus of a mobile device to: infer a location of said mobile device as being on a particular floor of a multi-floor building based, at least in part, on acquisition of one or more radio frequency signals; and combine said inference of said location of said mobile device with barometric pressure measurements obtained from said one or more barometric sensors to infer said location.

In another particular implementation, an apparatus comprises: means for inferring a location of said mobile device as being on a particular floor of a multi-floor building based, at least in part, on acquisition of one or more radio frequency signals; and means for combining said inference of said location of said mobile device with barometric pressure measurements obtained from a barometric sensor device to infer said location.

It should be understood that the aforementioned implementations are merely example implementations, and that claimed subject matter is not necessarily limited to any particular aspect of these example implementations.

### DETAILED DESCRIPTION

In particular implementations of indoor navigation applications, it may be useful to determine an altitude of a mobile device. This may be particularly useful in navigating multi-story environments in which a client mobile device may be provided with navigation assistance data such as locations of transmitters, radio heatmaps, digital maps for display, routing maps, etc. As positioning assistance data for navigating an entire multi-story structure may be voluminous, a client mobile device may only be provided with localized positioning assistance data depending, for example, on the general location of the mobile device (e.g., particular floor or wing of a building). In particular implementation, a mobile device may be determined to be located on a particular floor of a building using one or more positioning techniques. The client mobile device may then be provided with positioning assistance data for use on that particular floor (e.g., including locations of transmitters located on the floor, a digital map for display to assist in navigating the floor, etc.).

In a particular implementation, a mobile device may resolve its location as being a particular floor of a building by acquiring signals transmitted by transmitters positioned at known locations. Here, a mobile device may acquire a MAC address or other information modulating a signal transmitted by a transmitter (e.g., IEEE std. 802.11 access point) in range of the mobile device to infer that the mobile device is relatively close to the transmitter located on a particular building floor. This technique, however, may be unreliable if a particular access point or transmitter transmits a signal that may be acquired by a mobile device on any one of multiple floors of the building. For example, this may lead to a determined floor of a mobile device to oscillate or “ping-pong” between adjacent floors of a building.

In another particular implementation, mobile device may resolve its location as being on a particular floor of a building by obtaining barometric pressure measurements at a built-in barometric pressure sensor. In practice, however, computing an altitude of a mobile device from barometric pressure measurements may pose a problem because the mobile device may not by itself determine the current atmospheric pressure at sea level or other reference pressure which varies depending on local weather conditions. Unless the reference pressure is provided to the mobile device by some external source, the mobile device may not be able to use atmospheric pressure measurements to determine its absolute altitude (or building floor).

According to an embodiment, a floor of a location of a mobile device may be resolved based, at least in part, on a combination of acquired RF signals and barometric pressure measurements. For example, a particular floor of a multi-floor building where the mobile device is located may be probabilistically modeled based, at least in part, on barometric pressure measurements and acquired RF signals. This may reduce the incidence of oscillation or “ping-pong” of a location of a mobile device between floors of a building.

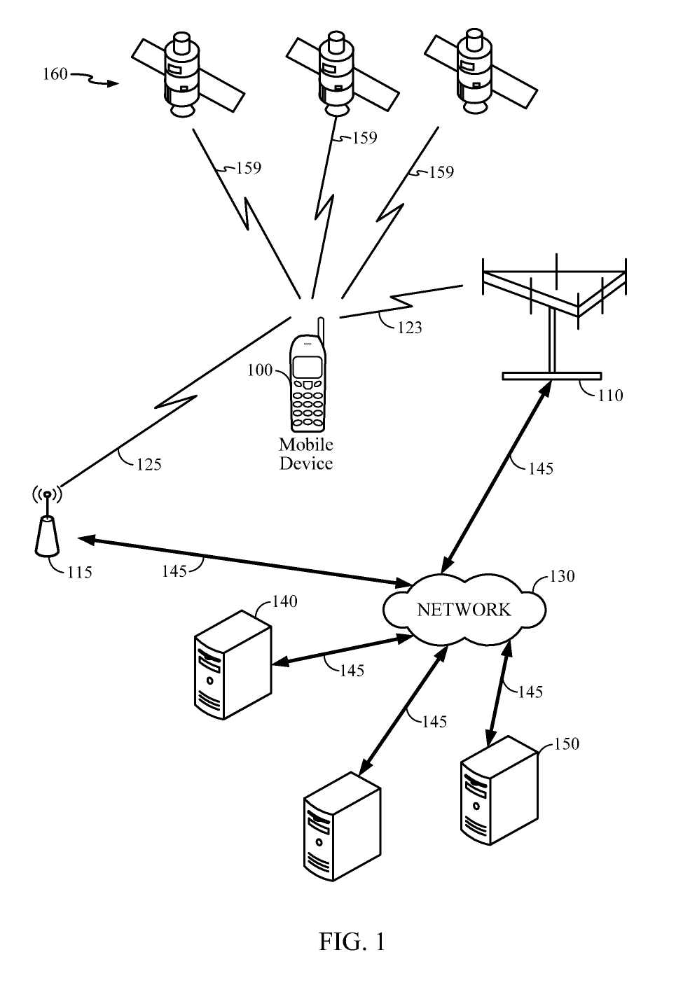

In certain implementations, as shown in FIG. 1, a mobile device 100 may receive or acquire satellite positioning system (SPS) signals 159 from SPS satellites 160. In some embodiments, SPS satellites 160 may be from one global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSS') such as, for example, Wide Area Augmentation System (WAAS), European Geostationary Navigation Overlay Service (EGNOS), Quasi-Zenith Satellite System (QZSS), just to name a few examples.

In addition, the mobile device 100 may transmit radio signals to, and receive radio signals from, a wireless communication network. In one example, mobile device may communicate with a cellular communication network by transmitting wireless signals to, or receiving wireless signals from, a base station transceiver 110 over a wireless communication link 123. Similarly, mobile device 100 may transmit wireless signals to, or receive wireless signals from a local transceiver 115 over a wireless communication link 125.

In a particular implementation, local transceiver 115 may be configured to communicate with mobile device 100 at a shorter range over wireless communication link 125 than at a range enabled by base station transceiver 110 over wireless communication link 123. For example, local transceiver 115 may be positioned in an indoor environment. Local transceiver 115 may provide access to a wireless local area network (WLAN, e.g., IEEE Std. 802.11 network) or wireless personal area network (WPAN, e.g., Bluetooth network). In another example implementation, local transceiver 115 may comprise a femto cell transceiver capable of facilitating communication on link 125 according to a cellular communication protocol. Of course it should be understood that these are merely examples of networks that may communicate with a mobile device over a wireless link, and claimed subject matter is not limited in this respect.

In a particular implementation, base station transceiver 110 and local transceiver 115 may communicate with servers 140, 150 and 155 over a network 130 through links 145. Here, network 130 may comprise any combination of wired or wireless links. In a particular implementation, network 130 may comprise Internet Protocol (IP) infrastructure capable of facilitating communication between mobile device 100 and servers 140, 150 or 155 through local transceiver 115 or base station transceiver 150. In another implementation, network 130 may comprise cellular communication network infrastructure such as, for example, a base station controller or master switching center (not shown) to facilitate mobile cellular communication with mobile device 100.

In particular implementations, and as discussed below, mobile device 100 may have circuitry and processing resources capable of computing a position fix or estimated location of mobile device 100. For example, mobile device 100 may compute a position fix based, at least in part, on pseudorange measurements to four or more SPS satellites 160. Here, mobile device 100 may compute such pseudorange measurements based, at least in part, on pseudonoise code phase detections in signals 159 acquired from four or more SPS satellites 160. In particular implementations, mobile device 100 may receive from server 140, 150 or 155 positioning assistance data to aid in the acquisition of signals 159 transmitted by SPS satellites 160 including, for example, almanac, ephemeris data, Doppler search windows, just to name a few examples.

In other implementations, mobile device 100 may obtain a position fix by processing signals received from terrestrial transmitters fixed at known locations (e.g., such as base station transceiver 110) using any one of several techniques such as, for example, advanced forward trilateration (AFLT) and/or observed time difference of arrival (OTDOA). In these particular techniques, a range from mobile device 100 may be measured to three or more of such terrestrial transmitters fixed at known locations based, at least in part, on pilot signals transmitted by the transmitters fixed at known locations and received at mobile device 100. Here, servers 140, 150 or 155 may be capable of providing positioning assistance data to mobile device 100 including, for example, locations and identities of terrestrial transmitters to facilitate positioning techniques such as AFLT and OTDOA. For example, servers 140, 150 or 155 may include a base station almanac (BSA) which indicates locations and identities of cellular base stations in a particular region or regions.

In particular environments such as indoor environments or urban canyons, mobile device 100 may not be capable of acquiring signals 159 from a sufficient number of SPS satellites 160 or perform AFLT or OTDOA to compute a position fix. Alternatively, mobile device 100 may be capable of computing a position fix based, at least in part, on signals acquired from local transmitters (e.g., WLAN access points positioned at known locations). For example, mobile devices may obtain a position fix by measuring ranges to three or more indoor terrestrial wireless access points which are positioned at known locations. Such ranges may be measured, for example, by obtaining a MAC ID address from signals received from such access points and obtaining range measurements to the access points by measuring one or more characteristics of signals received from such access points such as, for example, received signal strength (RSSI), round trip time (RTT) or angle of arrival (AOA). In alternative implementations, mobile device 100 may obtain an indoor position fix by applying characteristics of acquired signals to a radio heatmap indicating expected RSSI and/or RTT signatures at particular locations in an indoor area. In particular implementations, a radio heatmap may associate identities of local transmitters (e.g., a MAD address which is discernible from a signal acquired from a local transmitter), expected RSSI from signals transmitted by the identified local transmitters, an expected RTT from the identified transmitters, and possibly standard deviations from these expected RSSI or RTT. It should be understood, however, that these are merely examples of values that may be stored in a radio heatmap, and that claimed subject matter is not limited in this respect.

In particular implementations, mobile device 100 may receive positioning assistance data for indoor positioning operations from servers 140, 150 or 155. For example, such positioning assistance data may include locations and identities of transmitters positioned at known locations to enable measuring ranges to these transmitters based, at least in part, on a measured RSSI and/or RTT, for example. Other positioning assistance data to aid indoor positioning operations may include radio heatmaps, magnetic heatmaps, locations and identities of transmitters, routeability graphs, just to name a few examples. Other positioning assistance data received by the mobile device may include, for example, local maps of indoor areas for display or to aid in navigation. Such a map may be provided to mobile device 100 as mobile device 100 enters a particular indoor area. Such a map may show indoor features such as doors, hallways, entry ways, walls, etc., points of interest such as bathrooms, pay phones, room names, stores, etc. By obtaining and displaying such a map, a mobile device may overlay a current location of the mobile device (and user) over the displayed map to provide the user with additional context.

In one implementation, a routeability graph and/or digital map may assist mobile device 100 in defining feasible areas for navigation within an indoor area and subject to physical obstructions (e.g., walls) and passage ways (e.g., doorways in walls). Here, by defining feasible areas for navigation, mobile device 100 may apply constraints to aid in the application of filtering measurements for estimating locations and/or motion trajectories according to a motion model (e.g., according to a particle filter and/or Kalman filter). In addition to measurements obtained from the acquisition of signals from local transmitters, according to a particular embodiment, mobile device 100 may further apply a motion model to measurements or inferences obtained from inertial sensors (e.g., accelerometers, gyroscopes, magnetometers, etc.) and/or environment sensors (e.g., temperature sensors, microphones, barometric pressure sensors, ambient light sensors, camera imager, etc.) in estimating a location or motion state of mobile device 100.

According to an embodiment, mobile device 100 may access indoor positioning assistance data through servers 140, 150 or 155 by, for example, requesting the indoor assistance data through selection of a universal resource locator (URL). In particular implementations, servers 140, 150 or 155 may be capable of providing indoor positioning assistance data to cover many different indoor areas including, for example, floors of buildings, wings of hospitals, terminals at an airport, portions of a university campus, areas of a large shopping mall, just to name a few examples. Also, memory resources at mobile device 100 and data transmission resources may make receipt of indoor positioning assistance data for all areas served by servers 140, 150 or 155 impractical or infeasible, a request for indoor positioning assistance data from mobile device 100 may indicate a rough or course estimate of a location of mobile device 100. Mobile device 100 may then be provided indoor positioning assistance data covering areas including and/or proximate to the rough or course estimate of the location of mobile device 100.

In one particular implementation, a request for indoor positioning assistance data from mobile device 100 may specify a location context identifier (LCI). Such an LCI may be associated with a locally defined area such as, for example, a particular floor of a building or other indoor area which is not mapped according to a global coordinate system. In one example server architecture, upon entry of an area, mobile device 100 may request a first server, such as server 140, to provide one or more LCIs covering the area or adjacent areas. Here, the request from the mobile device 100 may include a rough location of mobile device 100 such that the requested server may associate the rough location with areas covered by known LCIs, and then transmit those LCIs to mobile device 100. Mobile device 100 may then use the received LCIs in subsequent messages with a different server, such as server 150, for obtaining positioning assistance data relevant to an area identifiable by one or more of the LCIs as discussed above (e.g., digital maps, locations and identifies of beacon transmitters, radio heatmaps or routeability graphs).

In particular implementations, a mobile device may determine its rough location (e.g., for obtaining an LCI) based, at least in part, on acquisition of an RF signal such as an RF signal transmitted by a transmitter positioned a known fixed location. The mobile device may extract a MAC address from the acquired signal, and associate the MAC address with a known location of the known fixed location. In a multistoried building, however, acquisition of an RF signal may be misleading if the acquiring mobile device and the transmitter are on different floors (but within a vertical range for the mobile device to acquire the transmitted RF signal). This may lead to obtaining an LCI (and associated positioning assistance data) that is not useful or relevant for the mobile device at its actual current location.

As pointed out above, particular implementations are directed to combining barometric pressure measurements with acquired RF signals (e.g., WiFi or IEEE 802.11 signals) to associate a location of a mobile device with a particular floor of a building or LCI. As discussed below, a correlating WiFi measurements with altitude transitions detected by barometric sensor measurements may reduce oscillations or “ping-pong” of an assumed location of a mobile device between floors of a building.

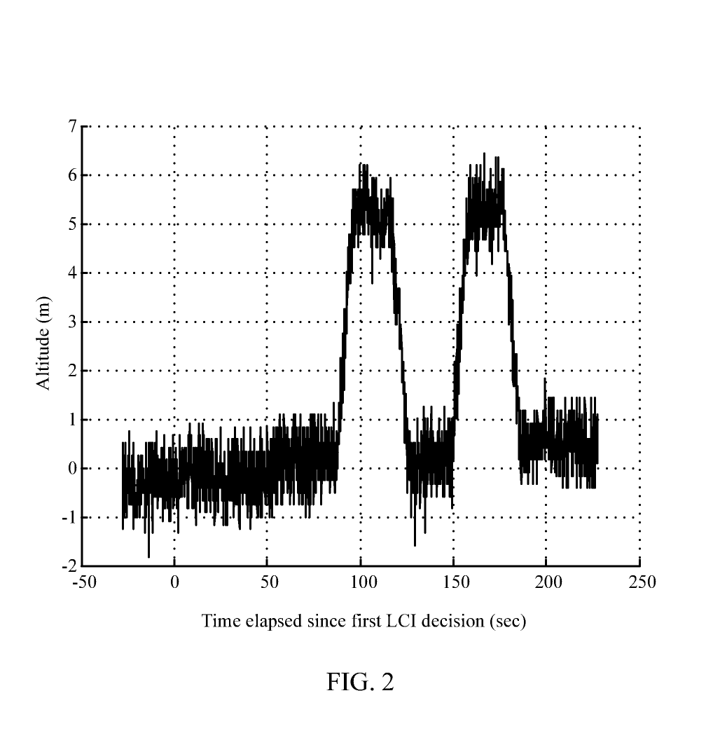

FIG. 2 is a plot of an altitude of a mobile device as tracked based on measurements of barometric pressure at the mobile device. In this particular example, the mobile device is in an elevator beginning at a first level, and transitions to an altitude of about 6.0 m above the first level at about 100.0 seconds, then back down to the first level at about 125.0 seconds, then back to about 6.0 m at about 150.0 seconds and then returning to the first level at about 180.0 seconds.

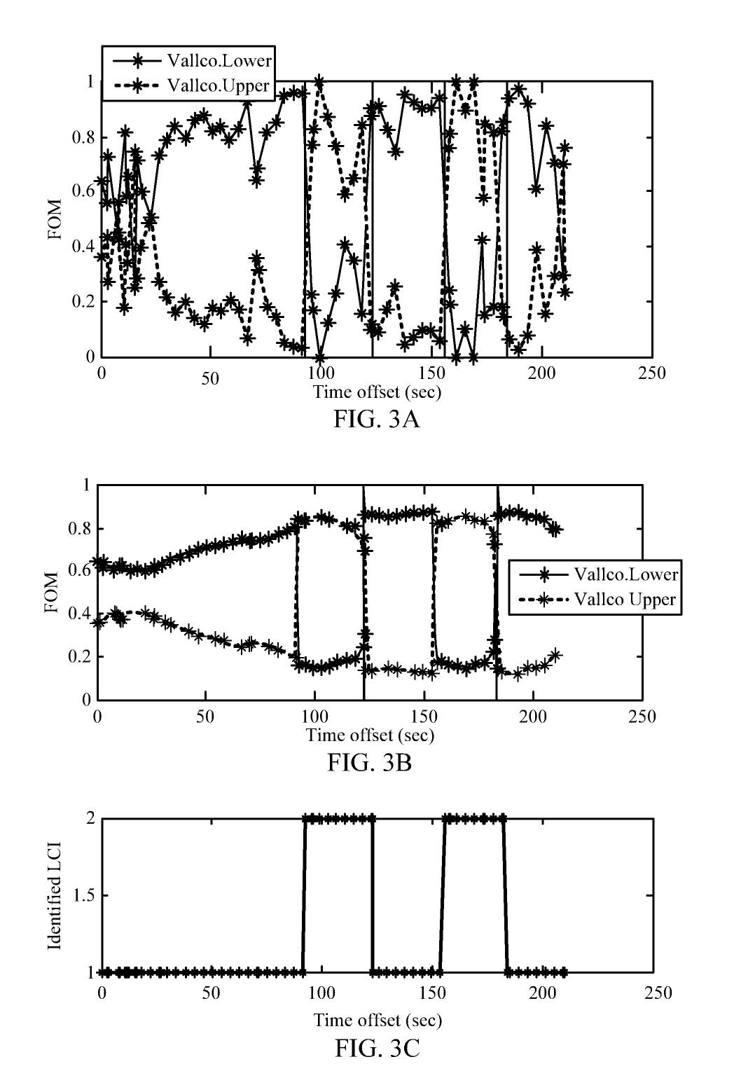

FIGS. 3A, 3B and 3C show plots of decisions to select an appropriate LCI given a mobile device's current location based on WiFi signal (e.g., signals transmitted by IEEE 802.11 access points) acquisitions/measurements and/or barometric pressure measurements. For simplicity, FIGS. 3A, 3B and 3C illustrate responses to movement of a mobile device between two floors. In a particular implementation, a mobile device may select from among multiple hypotheses as to a particular floor of a building that includes the location of the mobile device. As illustrated in the particular examples of FIGS. 3A, 3B and 3C, the mobile device may be one of two different floors. It should be understood, however, that the techniques described herein may be extended to cover movement among three or more floors without deviating from claimed subject matter. As discussed below, a figure of merit (FOM) may be computed for a particular hypothesis to indicate a probability of likelihood that the hypothesis is true (e.g., the mobile device is actually located on a particular floor of the building).

FIG. 3A shows a plot of FOMs for the hypotheses of the location of a mobile device being on either of two different floors based on WiFi signal acquisitions/measurements independently of barometric pressure measurements. A computed FOM for the possibility of the location of the mobile being on one floor is shown by a solid-lined plot while a computed FOM for the possibility of the location of the mobile device being on another floor is shown by a broken-lined plot. At certain points, the computed FOMs are sufficiently separated to easily resolve between floors such as at about 50 s. where the FOM represented by the solid line is much higher than the FOM represented by the solid line. In other regions such as at about 110 s. or 175 s., the computed FOMs are not significantly separated.

FIG. 3B shows a fusion of WiFi signal acquisitions/measurements with barometric pressure measurements in which changes in LCI detected from Wifi signals may be confirmed or disconfirmed from detected changes in altitude based on barometric pressure measurements. Again, a computed FOM for the possibility of the location of the mobile being on one floor is shown by a solid-lined plot while a computed FOM for the possibility of the location of the mobile device being on another floor is shown by a broken-lined plot. As may be observed, by about 50 s. computed FOMs for the different hypotheses are significantly separated to enable a simple selection of a hypothesis (e.g., particular floor where mobile device is located). FIG. 3C shows a plot of resulting LCI selection decisions or inferences based on a hypothesis selected based on FOMs plotted in FIG. 3B.

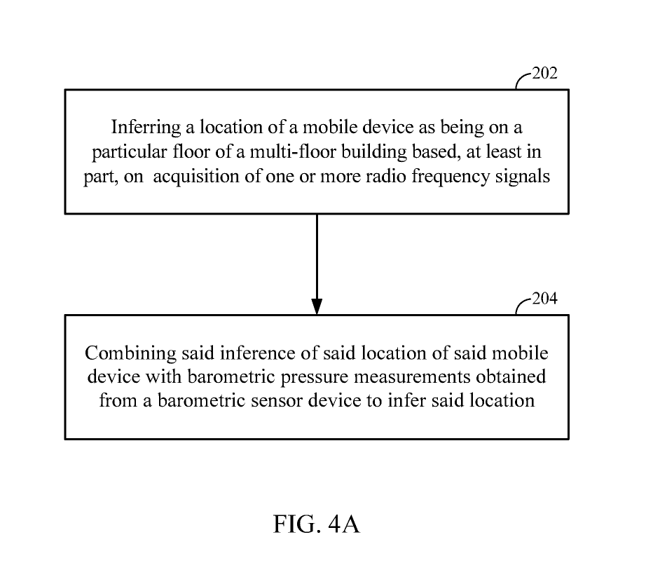

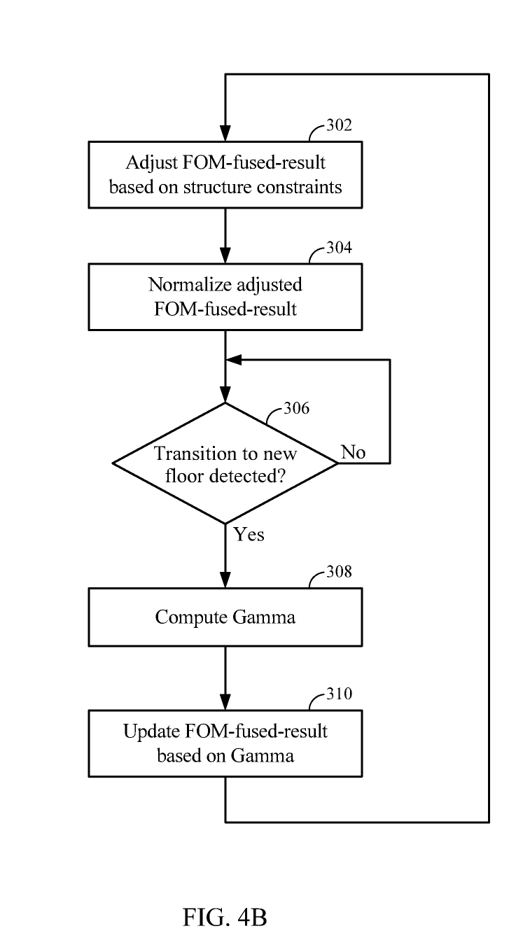

FIG. 4A is a flow diagram of a process for combining the acquisition of RF signals with barometric pressure measurements for estimating an aspect of a location of a mobile device in accordance with an embodiment. In a particular implementation, the process depicted in FIG. 4A may be executed and/or controlled by a mobile device that is capable of obtaining barometric pressure measurements (e.g., using a barometric pressure sensor) and capable of acquiring RF signals (e.g., at an RF receiver device). At block 202, a location of a mobile device as being on a particular floor of a multi-floor building may be approximated based, at least in part, on acquisition of one or more radio frequency signals. In one example, positioning assistance data may include indications of fixed locations of transmitters referenced by respective MAC addresses. These fixed locations may include, for example, a particular floor of a multistory building and a location on the particular floor (e.g., as referenced by a map of an indoor area). Obtaining a MAC address from a signal acquired from a particular transmitter, a mobile device may associate its location as being proximate to the particular transmitter and perhaps being on the same floor as the particular transmitter. As pointed out above, however, the particular transmitter may actually located on a floor different from the location of the mobile device (but is still in range for the mobile device to acquire). Here, such an inference that the mobile device is located on the same floor as the particular transmitter would be erroneous.

At block 204, an inference of a location of the mobile device obtained at block 202 may be combined with barometric pressure measurements obtained from a barometric sensor device to infer the location of the mobile device. For example, block 204 may confirm or disconfirm an inference that the location of the mobile device has transitioned between floors. For example, if an acquisition of a WiFi signal indicates a change in location between adjacent floors and measured barometric pressure similarly indicates such a change in altitude during this transition, the inference obtained at block 204 may be confirmed. Conversely, if an acquisition of a WiFi signal indicates a change in location between adjacent floors but measured barometric pressure does not indicate such a change in altitude during this transition, the inference obtained at block 204 may be disconfirmed.

In a particular example, block 202 may indicate a transition to a higher floor. If barometric pressure decreases during this transition by an amount indicative of the increase in altitude at the higher floor, block 204 may confirm this inference obtained at block 202. Otherwise, if barometric pressure does not change or increases, for example, block 204 may disconfirm this inference.

In another particular example, block 202 may indicate a transition to a lower floor. If barometric pressure increases during this transition by an amount indicative of a decrease in altitude at the lower floor, block 204 may confirm this inference obtained at block 202. Otherwise, if barometric pressure does not change or decreases, for example, block 204 may disconfirm this inference.

In another implementation, block 204 may maintain and update a figure of merit (FOM) comprising a vector containing likelihoods or probabilities that a mobile device is on a particular floor or area covered by a particular LCI. The floor associated with the highest likelihood or probability in the vector may then be selected as the floor having the location of the mobile device. In one implementation, such an FOM vector or array may be computed or derived separately based on WiFi signal acquisitions denoted as FOM_wifi and on WiFi signal acquisitions combined or filtered with barometric pressure measurements denoted as FOM_fused_result. In an example implementation, FOM_fused_result may comprise an array of elements corresponding to floors of a building. These elements may contain probability values indicating a likelihood that a mobile device is located on respective floors corresponding to the elements. In a particular implementation, FOM_fused_result may be updated based, at least in part, on barometric pressure measurements (either alone or in combination with WiFi signal acquisitions). In a particular example implementation, as described below, FOM_fused_result may be computed based, at least in part, on a weighted combination of FOM_wifi using the altitude change from the last visited LCI. Such a change in altitude change may be measured based, at least in part, on barometric pressure measurements.

As pointed out above, an increase or decrease in measured barometric pressure may indicate possible transitions between floors. With knowledge of altitudes of floors in the building and altitude change measured based on barometric pressure measurements, a likelihood of mobile device's current floor can be predicted and updated by a newly received FOM_wifi. For example, in a building with three floors, altitudes of the floors may be [0 5 7] m. These three altitudes may form a vector called Floor_height. For example, suppose at a time instant barometer measurements indicate a 2 m increase in altitude from a place where FOM_fused_result has been computed as [0.7 0.2 0.1]. Using these barometer measurements, values of a previous FOM_fused_result may be adjusted to [0.7 0.2 0]/(0.7+0.1) because it is not possible for the mobile device to transition upward transition starting from the third floor. Here, the probability value 0.1 of the third element in the previously computed FOM_fused_result is pruned because it conflicts the increase in altitude suggested by the barometer pressure measurements. In this manner, values in entries for FOM_fused_result may be pruned based on barometric pressure measurements and knowledge of floor altitudes derived from structure constraints. Also, the newly received FOM_wifi may be combined with the FOM_fused_result using a moving average algorithm. An example process of pruning and updating entries in FOM_fused_result based on structure constraints is shown in the pseudo code of Steps 1 and 2 below. Here, a value for altitude change may be computed based, at least in part, on barometric pressure measurements obtained from a barometric pressure sensor. A value for Floor_height[i] may represent a height at an ith floor of the building. A value for THR may represent a constant height threshold. This threshold value may be chosen according to barometer's measurement noise variance. For some particular commercial barometers, this value can be 2.0 m.

### Step 1: For all i:

If Floor_height[i]+altitude change<Floor_height[1]−THR OR: Floor_height[i]+altitude change>Floor_height[end]+THR:
FOM_fused_result[i]=0

Elseif Floor_height[i]+altitude change is closest to Floor_height[j]:
FOM_fused_result[i]=N*FOM_fused_result[i]+FOM_wifi[j]
   where N is the number of previously received Wifi_FOM

### Step 2: Normalization:

FOM_fused_result=FOM_fused_result/sum(FOM_fused_result)

At Step 1 above, a value in FOM_fused_results[i] will be made “0” if a measured altitude change would place the altitude outside of constraints of the building (e.g., above the top floor or below the bottom floor. Following a change of a value for FOM_fused_results[i] to “0,” Step 2 may normalize values in remaining elements of FOM_fused_results to sum to 1.0.

Following Steps 1 and 2 above, if the mobile device reaches a new floor and stays there for a particular duration, the FOM_fused_result may be updated according to a change in altitude of the mobile device and knowledge of altitudes of floors. Since the mobile device stays on a floor after a transition, barometric measurements from a barometer may be stable at this time. This event may be detected by checking a variance of the barometric pressure measurements over a certain time interval. Once such an event is detected, a value for a new FOM_fused_result may be computed based, at least in part, on the newly reached floor (e.g., as determined from the FOM_fused_result defined on a previously reached floor) using a Markov transition matrix Gamma. An updated FOM_fused_result may be computed according to Steps A, B and C as follows:

Step A: For the building with n floors, initialize a n×n matrix Gamma with all elements being zeros.

### Step B: For all i:

If Floor_height[i]+altitude change is closest to Floor_height[j]:
Gamma[i][j]=1

### Step C: Update FOM_fused_result:

FOM_fused_result=Gamma*FOM_fused_result

An example process for updating FOM_fused_result may incorporating Steps 1 and 2, and Steps A, B and C be computed is illustrated in FIG. 4B. At block 302, an adjusted FOM_fused_result may be determined based, at least in part, on Step 1 above and then normalized at block 304 according to Step 2. Diamond 306 may detect a transition to a new floor based, at least in part, on a change in barometric pressure as measured from a barometer and subsequent stability and small variation in barometric pressure measurements. A matrix for Gamma may be updated at block 308 according to Steps A and B, and an updated FOM_fused_result may be computed based on block 310.

In an alternative implementation, block 204 may apply adaptively weight values for FOM_wifi with previous values for FOM_fused_result in computing new values for FOM_fused_result. For example, if barometric pressure measurements indicate no change in floor (e.g., barometric pressure does not increase or decrease by a sufficient amount to indicate a change in floor), a value for FOM_fused_result may be updated as a weighted combination of a previous FOM_fused_result and FOM_wifi according to relation (1) as follows:

$$FOM\_fused \_result = \frac{wt\_old}{wt\_old + wt\_new} FOM\_fused \_result + \frac{wt\_new}{wt\_old + wt\_new} FOM\_wifi \\ wt\_new = 1 - EntropyRatio * Curr\_entropy \\ wt\_old = min ( N , 10 ) , \\ where \\ N is the number of the previous results \qquad ( 1 )$$

On the other hand, if barometric pressure measurements indicate a change to a higher floor, a value for FOM_fused_result computed according to relation (1) may be updated according to relation (2) as follows:
FOM_fused_result=Gamma_up*FOM_fused_result

Where:

$$Gamma\_up = [ \begin{matrix}1 - Tp & 0 & 0 & … & 0 \\ Tp & 1 - Tp & 0 & … & 0 \\ 0 & Tp & 1 - Tp & … & 0 \\ ⋮ & ⋮ & ⋱ & ⋱ & ⋮ \\ 0 & 0 & 0 & … & 1\end{matrix} ] ; \\ and \\ {T}_{p} is a probability of transitioning between adajcent floors . \qquad ( 2 )$$

In another embodiment, a value of wt_new as applied in relation (1) may be adjusted or updated based, at least in part, on a computed entropy of the vector FOM_wifi. In a particular example in which there are two floors or LCIs, FOM_wifi may comprise a two-dimensional vector. Two example computations of an entropy for FOM_wifi may be as follows:

If FOM_wifi=[0.5 0.5]^{T},
Curr_entropy=−log₂(0.5)*0.5−log₂(0.5)*0.5=1

If FOM_wifi=[10]^{T},
Curr_entropy=−log₂(1)*1−log₂(0)=0

In a particular implementation, a relative difference in altitude between floors of a building may be unknown. In a particular embodiment, altitudes of floors of a building may be mapped based, at least in part, on crowdsourced measurements of barometric pressure obtained from mobile devices. For example, a relative altitude from floor transitions detected by a barometric measurements may be used in conjunction with decisions on floor/LCI location assisted by barometric measurements to estimate relative differences between floor heights. In one example, if a combined decision has a high confidence (e.g., >90%) that a current location of a mobile device is on a floor covered by a particular LCI, the level of that current location to a reference altitude (e.g., an altitude of a bottom floor). Accordingly, these relative differences may then be used to estimate floor to ceiling heights. These inferences of floor to ceiling heights may then be transmitted back to a server to be used in updating positioning assistance data.

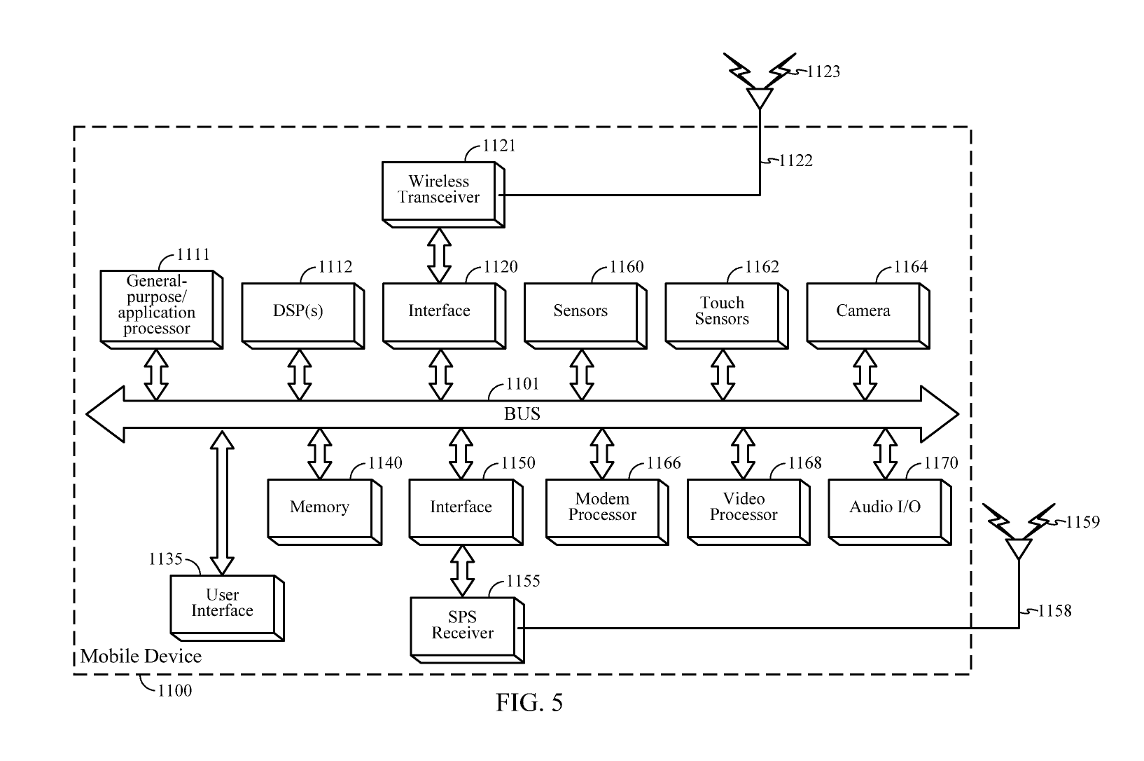

FIG. 5 is a schematic diagram of a mobile device according to an embodiment. Mobile device 100 (FIG. 1) may comprise one or more features of mobile device 1100 shown in FIG. 5. In certain embodiments, mobile device 1100 may also comprise a wireless transceiver 1121 which is capable of transmitting and receiving wireless signals 1123 via an antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, WiFi, CDMA, WCDMA, LTE and Bluetooth, just to name a few examples.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown).

Also shown in FIG. 5, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein.

Also shown in FIG. 5, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) 1112 or general purpose/application processor 1111 in support of one or more applications such as, for example, applications directed to positioning or navigation operations. For example, DSP(s) 1112 or general purpose/application processor 1111 may be capable of performing all or a portion of actions of the process indicated in blocks 202 and 204 of FIG. 4. In addition, an inference at block 202 may be obtained based, at least in part, on RF signals acquired at wireless transceiver 1121. Furthermore, barometric pressure measurements combined with an inference obtained at block 202 may be obtained from a barometric sensor of sensors 1160.

In a particular implementation, mobile device 1100 may comprise a dedicated modem processor 1166 capable of performing baseband processing of signals received and downconverted at wireless transceiver 1121 or SPS receiver 1155. Similarly, modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

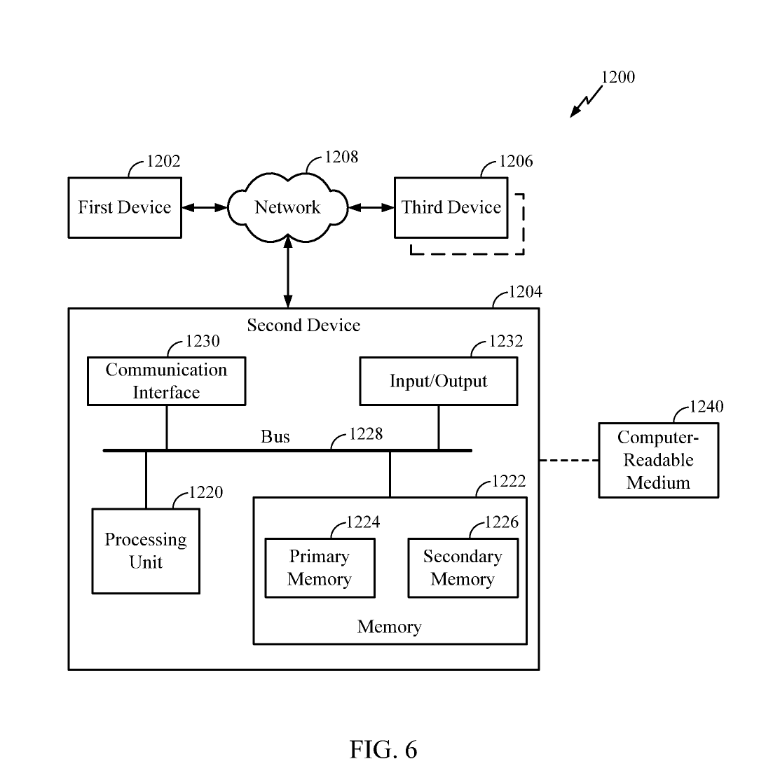

FIG. 6 is a schematic diagram illustrating an example system 1200 that may include one or more devices configurable to implement techniques or processes described above, for example, in connection with FIG. 1. System 1200 may include, for example, a first device 1202, a second device 1204, and a third device 1206, which may be operatively coupled together through a wireless communications network 1208. In an aspect, first device 1202 may comprise a server capable of providing positioning assistance data such as, for example, a base station almanac. First device 1202 may also comprise a server capable of providing an LCI to a requesting mobile device based, at least in part, on a rough estimate of a location of the requesting mobile device. First device 1202 may also comprise a server capable of providing indoor positioning assistance data relevant to a location of an LCI specified in a request from a mobile device. Second and third devices 1204 and 1206 may comprise mobile devices, in an aspect. Also, in an aspect, wireless communications network 1208 may comprise one or more wireless access points, for example. However, claimed subject matter is not limited in scope in these respects.

First device 1202, second device 1204 and third device 1206, as shown in FIG. 6, may be representative of any device, appliance or machine that may be configurable to exchange data over wireless communications network 1208. By way of example but not limitation, any of first device 1202, second device 1204, or third device 1206 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1202, 1204, and 1206, respectively, may comprise one or more of a base station almanac server, a base station, or a mobile device in accordance with the examples described herein.

Similarly, wireless communications network 1208, as shown in FIG. 6, is representative of one or more communication links, processes, or resources configurable to support the exchange of data between at least two of first device 1202, second device 1204, and third device 1206. By way of example but not limitation, wireless communications network 1208 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1206, there may be additional like devices operatively coupled to wireless communications network 1208.

It is recognized that all or part of the various devices and networks shown in system 1200, and the processes and methods as further described herein, may be implemented using or otherwise including hardware, firmware, software, or any combination thereof.

Thus, by way of example but not limitation, second device 1204 may include at least one processing unit 1220 that is operatively coupled to a memory 1222 through a bus 1228.

Processing unit 1220 is representative of one or more circuits configurable to perform at least a portion of a data computing procedure or process. By way of example but not limitation, processing unit 1220 may include one or more processors, controllers, microprocessors, microcontrollers, application specific integrated circuits, digital signal processors, programmable logic devices, field programmable gate arrays, and the like, or any combination thereof.

Memory 1222 is representative of any data storage mechanism. Memory 1222 may include, for example, a primary memory 1224 or a secondary memory 1226. Primary memory 1224 may include, for example, a random access memory, read only memory, etc. While illustrated in this example as being separate from processing unit 1220, it should be understood that all or part of primary memory 1224 may be provided within or otherwise co-located/coupled with processing unit 1220.

Secondary memory 1226 may include, for example, the same or similar type of memory as primary memory or one or more data storage devices or systems, such as, for example, a disk drive, an optical disc drive, a tape drive, a solid state memory drive, etc. In certain implementations, secondary memory 1226 may be operatively receptive of, or otherwise configurable to couple to, a computer-readable medium 1240. Computer-readable medium 1240 may include, for example, any non-transitory medium that can carry or make accessible data, code or instructions for one or more of the devices in system 1200. Computer-readable medium 1240 may also be referred to as a storage medium.

Second device 1204 may include, for example, a communication interface 1030 that provides for or otherwise supports the operative coupling of second device 1204 to at least wireless communications network 1208. By way of example but not limitation, communication interface 1230 may include a network interface device or card, a modem, a router, a switch, a transceiver, and the like.

Second device 1204 may include, for example, an input/output device 1232. Input/output device 1232 is representative of one or more devices or features that may be configurable to accept or otherwise introduce human or machine inputs, or one or more devices or features that may be configurable to deliver or otherwise provide for human or machine outputs. By way of example but not limitation, input/output device 1232 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATS”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femto cell, utilized to extend cellular telephone service into a business or home. In such an implementation, one or more mobile devices may communicate with a femto cell via a code division multiple access (“CDMA”) cellular communication protocol, for example, and the femto cell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method comprising, at a mobile device:
obtaining an inference of a location of said mobile device as being on a particular floor of a multi-floor building based, at least in part, on acquisition of one or more radio frequency signals; and
combining said inference of said location of said mobile device with barometric pressure measurements obtained from a barometric sensor device to infer said location.

2. The method of claim 1, wherein combining said inference of said location with said barometric pressure measurements further comprises confirming or disconfirming a detected change in said location of said mobile device between floors of said multi-floor building based, at least in part, on any detected change in altitude of said mobile device based on said barometric pressure measurements.

3. The method of claim 2, wherein said inference of said location comprises an inference that said mobile device has transitioned to a higher floor, and wherein said inference of said location is confirmed based, at least in part, on a decrease in measured barometric pressure.

4. The method of claim 2, wherein said inference of said location comprises an inference that said mobile device has transitioned to a higher floor, and wherein said inference is disconfirmed based, at least in part, on an absence of a decrease in measured barometric pressure.

5. The method of claim 2, wherein said inference of said location comprises an inference that said mobile device has transitioned to a lower floor, and wherein said inference of said location is confirmed based, at least in part, on an increase in measured barometric pressure.

6. The method of claim 2, wherein said inference of said location comprises an inference that said mobile device has transitioned to a lower floor, and wherein said inference is disconfirmed based, at least in part, on an absence of an increase in measured barometric pressure.

7. The method of claim 1, wherein said combining said inference of said location with said barometric pressure measurements further comprises, in response to indication of no change in floor based on said barometric pressure measurements:
computing a first figure of merit based on wifi signal acquisition;
computing a second figure of merit based on a fusion of wifi signal acquisition and said barometric pressure measurements; and
updating said second figure of merit based, at least in part, on a weighted combination of said first and second figures of merit.

8. The method of claim 1, wherein said combining said inference of said location with said barometric pressure measurements further comprises, in response to indication of a change in floor based on said barometric pressure measurements updating a figure of merit of said inference of said location based, at least in part, as follows:
FOM_fused_result=Gamma_up*FOM_fused_result
where:
$$Gamma\_up = [ \begin{matrix}1 - Tp & 0 & 0 & … & 0 \\ Tp & 1 - Tp & 0 & … & 0 \\ 0 & Tp & 1 - Tp & … & 0 \\ ⋮ & ⋮ & ⋱ & ⋱ & ⋮ \\ 0 & 0 & 0 & … & 1\end{matrix} ] ;$$
$$and$$
Tp is a probability of transitioning between adjacent floors in said multi-floor building.

9. The method of claim 1, wherein said combining said inference of said location of said mobile device with said barometric pressure measurements further comprises:
defining an array containing elements representing probabilities that the mobile device is located on floors corresponding to said elements;
decreasing or zeroing a value of at least one of said elements in said array based, at least in part, on application of a structure constraint to a combination of a height at a building floor corresponding to said at least one of said elements with a change in altitude indicated by said barometric pressure measurements.

10. The method of claim 9, and further comprising in response to detection of transition to a new floor:
computing a transition matrix based, at least in part, on application of said change in altitude to values in said array; and
apply of said transition matrix to said array to update values stored in said array.

11. A mobile device comprising:
one or more barometric sensors to obtain barometric sensor measurements; and
one or more processors to:
obtain an inference of a location of said mobile device as being on a particular floor of a multi-floor building based, at least in part, on acquisition of one or more radio frequency signals; and
combine said inference of said location of said mobile device with barometric pressure measurements obtained from said one or more barometric sensors to infer said location.

12. The mobile device of claim 11, wherein said inference of said location is combined with said barometric pressure measurements by confirming or disconfirming a detected change in said location of said mobile device between floors of said multi-floor building based, at least in part, on any detected change in altitude of said mobile device based on said barometric pressure measurements.

13. The mobile device of claim 12, wherein said inference of said location comprises an inference that said mobile device has transitioned to a higher floor, and wherein said inference of said location is confirmed based, at least in part, on a decrease in measured barometric pressure.

14. The mobile device of claim 12, wherein said inference of said location comprises an inference that said mobile device has transitioned to a higher floor, and wherein said inference is disconfirmed based, at least in part, on an absence of a decrease in measured barometric pressure.

15. The mobile device of claim 12, wherein said inference of said location comprises an inference that said mobile device has transitioned to a lower floor, and wherein said inference of said location is confirmed based, at least in part, on an increase in measured barometric pressure.

16. The mobile device of claim 12, wherein said inference of said location comprises an inference that said mobile device has transitioned to a lower floor, and wherein said inference is disconfirmed based, at least in part, on an absence of an increase in measured barometric pressure.

17. The mobile device of claim 11, wherein in response to an indication of no change in floor based on said barometric pressure measurements said inference of said location is combined with said barometric pressure measurements by:
computing a first figure of merit based on WiFi signal acquisition;
computing a second figure of merit based on a fusion of WiFi signal acquisition and said barometric pressure measurements; and
updating said second figure of merit based, at least in part, on a weighted combination of said first and second figures of merit.

18. The mobile device of claim 11, wherein said inference of said location of said mobile device is combined with said barometric pressure measurements by:
defining an array containing elements representing probabilities that the mobile device is located on floors corresponding to said elements;
decreasing or zeroing a value of at least one of said elements in said array based, at least in part, on application of a structure constraint to a combination of a height at a building floor corresponding to said at least one of said elements with a change in altitude indicated by said barometric pressure measurements.

19. The mobile device of claim 18, wherein said one or more processors are further to, in response to detection of transition to a new floor:
compute a transition matrix based, at least in part, on application of said change in altitude to values in said array; and
apply said transition matrix to said array to updated values stored in said array.

20. An article comprising:
a non-transitory storage medium comprising machine-readable instructions stored thereon which are executable by a special purpose computing apparatus of a mobile device to:
obtain an inference of a location of said mobile device as being on a particular floor of a multi-floor building based, at least in part, on acquisition of one or more radio frequency signals; and
combine said inference of said location of said mobile device with barometric pressure measurements obtained from one or more barometric sensors to infer said location.

21. The article of claim 20, wherein said inference of said location is combined with said barometric pressure measurements by confirming or disconfirming a detected change in said location of said mobile device between floors of said multi-floor building based, at least in part, on any detected change in altitude of said mobile device based on said barometric pressure measurements.

22. The article of claim 21, wherein said inference comprises an inference that said mobile device has transitioned to a higher floor, and wherein said inference of said location is confirmed based, at least in part, on a decrease in measured barometric pressure.

23. The article of claim 21, wherein said inference of said location comprises an inference that said mobile device has transitioned to a higher floor, and wherein said inference of said location is disconfirmed based, at least in part, on an absence of a decrease in measured barometric pressure.

24. The article of claim 21, wherein said inference of said location comprises an inference that said mobile device has transitioned to a lower floor, and wherein said inference of said location is confirmed based, at least in part, on an increase in measured barometric pressure.

25. The article of claim 21, wherein said inference of said location comprises an inference that said mobile device has transitioned to a lower floor, and wherein said inference of said location is disconfirmed based, at least in part, on an absence of an increase in measured barometric pressure.

26. A mobile device comprising:
means for obtain an inference of a location of said mobile device as being on a particular floor of a multi-floor building based, at least in part, on acquisition of one or more radio frequency signals; and
means for combining said inference of said location of said mobile device with barometric pressure measurements obtained from a barometric sensor device to infer said location.

27. The apparatus of claim 26, wherein said means for combining said inference of said location with said barometric pressure measurements further comprises means for confirming or disconfirming a detected change in said location of said mobile device between floors of said multi-floor building based, at least in part, on any detected change in altitude of said mobile device based on said barometric pressure measurements.

28. The apparatus of claim 26, wherein said inference of said location comprises an inference that said mobile device has transitioned to a higher floor, and wherein said inference of said location is confirmed based, at least in part, on a decrease in measured barometric pressure.

29. The apparatus of claim 27, wherein said inference of said location comprises an inference that said mobile device has transitioned to a higher floor, and wherein said inference of said location is disconfirmed based, at least in part, on an absence of a decrease in measured barometric pressure.

30. The apparatus of claim 27, wherein said inference of said location comprises an inference that said mobile device has transitioned to a lower floor, and wherein said inference of said location is confirmed based, at least in part, on an increase in measured barometric pressure.
